(19) United States
(12) Patent Application Publication
(10) Pub. No.: US 2026/0086760 A1
(43) Pub. Date: Mar. 26, 2026

(54) DISPLAY CONTROL DEVICE AND DISPLAY CONTROL METHOD

(71) Applicant: Panasonic Automotive Systems Co., Ltd., Kanagawa (JP)

(72) Inventors: Yota KAMBAYASHI, Osaka (JP); Takanori SAKATA, Kanagawa (JP)

(73) Assignee: Panasonic Automotive Systems Co., Ltd., Kanagawa (JP)

(21) Appl. No.: 19/408,722

(22) Filed: Dec. 4, 2025

Related U.S. Application Data
(63) Continuation of application No. PCT/JP2024/028519, filed on Aug. 8, 2024.

(30) Foreign Application Priority Data
Sep. 29, 2023 (JP) 2023-169320

(51) Int. Cl. G06F 3/14; B60N 2/00; G06F 3/04817; G06F 3/0482; G06F 3/0484; G07C 5/02

(52) U.S. Cl. CPC G06F 3/1454; G06F 3/04817; G06F 3/0482; G06F 3/0484; G06F 3/1423; B60N 2/002; G07C 5/02

(57) ABSTRACT

A display control device includes: a first-operation detector that detects a first operation to output and display a target image on a second display device different from a first display device, the target image being an image displayed on the first display device among a plurality of display devices each of which is configured to display an image; an approval selection acceptor that, when the first operation is detected, accepts, via the second display device, a first selection as to whether to approve or disapprove outputting and displaying the target image on the second display device; and a controller that outputs the target image to the second display device to cause the second display device to display the target image when approval for outputting and displaying the target image on the second display device is selected.

### CROSS REFERENCE TO RELATED APPLICATIONS

This is a continuation application of PCT International Patent Application No. PCT/JP2024/028519 filed on Aug. 8, 2024, designating the United States of America, which is based on and claims priority of Japanese Patent Application No. 2023-169320 filed on Sep. 29, 2023.

### FIELD

The present disclosure relates to, for example, a display control device.

### BACKGROUND

For example, a device that controls displaying of an image on a display located in a vehicle is conventionally disclosed. For instance, Patent Literature (PTL) 1 discloses an in-vehicle display system that, when a display operation to output at least a part of first content to a second display is performed with the first content being output by a first display, selects either the first display or the second display to be associated with a permission to operate the output of at least one of the first display or the second display.

### CITATION LIST

### Patent Literature

PTL 1: International Publication WO 2017/068759

### SUMMARY

However, the display control disclosed in PTL 1 above can be improved upon.

In view of this, the present disclosure provides a display control device and so forth capable of improving upon the above

### RELATED ART

A display control device according to one aspect of the present disclosure includes: a first-operation detector that detects a first operation to output and display a target image on a second display device different from a first display device, the target image being an image displayed on the first display device among a plurality of display devices each of which is configured to display an image; a first-selection acceptor that, when the first operation is detected, accepts, via the second display device, a first selection as to whether to approve or disapprove outputting and displaying the target image on the second display device; and a controller that outputs the target image to the second display device to cause the second display device to display the target image when approval for outputting and displaying the target image on the second display device is selected.

Moreover, a display control method according to another aspect of the present disclosure includes: detecting a first operation to output and display a target image on a second display device different from a first display device, the target image being an image displayed on the first display device among a plurality of display devices each of which is configured to display an image; when the first operation is detected, accepting, via the second display device, a first selection as to whether to approve or disapprove outputting and displaying the target image on the second display device; and when approval for outputting and displaying the target image on the second display device is selected, outputting and displaying the target image on the second display device.

Moreover, a program according to yet another aspect of the present disclosure is a program for causing a computer to execute the above display control method.

It should be noted that these general or specific aspects may be achieved as a system, a method, an integrated circuit, a computer program, or a computer-readable recording medium such as a CD-ROM or may be achieved as any combinations of the system, method, integrated circuit, computer program, and recording medium. Moreover, the recording medium may be a non-transitory recording medium.

A display control device and so forth in the present disclosure are capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a schematic diagram of a vehicle provided with a display control device according to an embodiment.

FIG. 2 is a block diagram illustrating a hardware configuration of the display control device and so forth in FIG. 1.

FIG. 3 is a block diagram illustrating a functional configuration of the display control device and so forth in FIG. 1.

FIG. 4 is a flowchart illustrating an example of a display control method performed by the display control device in FIG. 1.

FIG. 5 is a figure for explaining a first operation example of the display control device in FIG. 1.

FIG. 6 is a figure for explaining a second operation example of the display control device in FIG. 1.

FIG. 7 is a figure for explaining a third operation example of the display control device in FIG. 1.

FIG. 8 is a figure for explaining a fourth operation example of the display control device in FIG. 1.

FIG. 9 is a figure for explaining a fifth operation example of the display control device in FIG. 1.

FIG. 10 is a figure for explaining a sixth operation example of the display control device in FIG. 1.

FIG. 11 is a figure for explaining a seventh operation example of the display control device in FIG. 1.

FIG. 12 is a figure for explaining an eighth operation example of the display control device in FIG. 1.

FIG. 13 is a flowchart illustrating another example of the display control method performed by the display control device in FIG. 1.

### DESCRIPTION OF EMBODIMENT

Incidentally, when an image displayed on a first display device is output to a second display device to cause the second display device to display the image, the image may be displayed on the second display device at an inappropriate time, depending on, for example, the usage status of the second display device. Thus, displaying of the image on the second display device at a more appropriate time is required. In view of this, the present disclosure provides a display control device and so forth capable of causing a second display device to display an image displayed on a first display device at a more appropriate time.

A display control device according to one aspect of the present disclosure includes: a first-operation detector that detects a first operation to output and display a target image on a second display device different from a first display device, the target image being an image displayed on the first display device among a plurality of display devices each of which is configured to display an image; a first-selection acceptor that, when the first operation is detected, accepts, via the second display device, a first selection as to whether to approve or disapprove outputting and displaying the target image on the second display device; and a controller that outputs the target image to the second display device to cause the second display device to display the target image when approval for outputting and displaying the target image on the second display device is selected.

In this way, when the approval for outputting and displaying the image displayed on the first display device on the second display device is selected, it is possible to display the image on the second display device. Since it is possible to suppress the image from being unintentionally displayed on the second display device, the image displayed on the first display device can be displayed on the second display device at a more appropriate time.

Moreover, in the display control device according to one aspect of the present disclosure, when disapproval for outputting and displaying the target image on the second display device is selected, the controller may prevent the second display device from displaying the target image.

In this way, when the disapproval for outputting and displaying the image displayed on the first display device on the second display device is selected, it is possible not to display the image on the second display device. Since it is possible to suppress the image from being unintentionally displayed on the second display device, the image displayed on the first display device can be displayed on the second display device at a more appropriate time.

Moreover, the display control device according to one aspect of the present disclosure may include: a first-setting acceptor that accepts a first setting to prevent the second display device from displaying the target image, in a situation where neither the approval nor disapproval for outputting and displaying the target image on the second display device is selected within a predetermined period from start of acceptance of the first selection. The controller may prevent the second display device from displaying the target image when the first setting is set in the situation where neither the approval nor the disapproval for outputting and displaying the target image on the second display device is selected within the predetermined period.

In this way, even when the disapproval for outputting and displaying the image displayed on the first display device on the second display device is not selected within the predetermined period, it is possible not to display the image on the second display device. Since it is possible to suppress the image from being unintentionally displayed on the second display device, the image displayed on the first display device can be displayed on the second display device at a more appropriate time.

Moreover, the display control device according to one aspect of the present disclosure may include: a second-selection acceptor that, when the first operation is detected, accepts, via the first display device, a second selection as to whether to stop outputting and displaying the target image on the second display device. If to stop outputting and displaying the target image on the second display device is selected, the controller may stop the target image from being output to and displayed on the second display device.

In this way, even when the disapproval for outputting and displaying the image displayed on the first display device on the second display device is not selected, by selecting to stop outputting and displaying the image on the second display device, it is possible not to display the image on the second display device. Since it is possible to suppress the image from being unintentionally displayed on the second display device, the image displayed on the first display device can be displayed on the second display device at a more appropriate time.

Moreover, in the display control device according to one aspect of the present disclosure, the first-selection acceptor may accept the first selection as a result of causing the second display device to display (i) options as to whether to approve or disapprove outputting and displaying the target image on the second display device or (ii) a thumbnail of the target image, and when an approval option for outputting and displaying the target image on the second display device is selected from the options, or when the thumbnail is tapped, the controller may output the target image to the second display device to cause the second display device to display the target image.

In this way, by using the options or the thumbnail, it is possible to readily select the approval or the disapproval for outputting and displaying the image displayed on the first display device on the second display device.

Moreover, in the display control device according to one aspect of the present disclosure, the first-selection acceptor may determine a position at which to display the options or the thumbnail on the second display device, according to a position of the first display device relative to the second display device, and cause the options or the thumbnail to be displayed at the position determined.

In this way, the position of the first display device can be estimated from the position of the options or the thumbnail. Thus, it is possible to readily estimate which display device's image will be output.

Moreover, in the display control device according to one aspect of the present disclosure, the plurality of display devices may include display devices that have a one-to-one correspondence with a plurality of seats in a vehicle including the plurality of seats, and are each configured to display the image viewable by a person seated in a corresponding one of the plurality of seats. The display control device may include: an occupancy information obtainer that obtains occupancy information indicating whether the person is seated in each of the plurality of seats, from an occupancy information detector that detects the occupancy information; and an occupancy determiner that determines whether the person is seated in each of the plurality of seats according to the occupancy information. When the first operation is detected, if the person is not seated in the seat corresponding to the second display device, the first-selection acceptor does not accept the first selection, and when the person is not seated in the seat corresponding to the second display device, the controller may output the target image to the second display device to cause the second display device to display the target image.

In this way, when a person is not seated in the seat corresponding to the second display device, the image displayed on the first display device can be readily output to and displayed on the second display device without the approval for outputting and displaying the image displayed on the first display device on the second display device.

Moreover, in the display control device according to one aspect of the present disclosure, the plurality of display devices may include display devices that have a one-to-one correspondence with a plurality of seats in a vehicle that includes the plurality of seats including a driver's seat, and are each configured to display the image viewable by a person seated in a corresponding one of the plurality of seats. The display control device may include: a driving information obtainer that obtains driving information indicating a driving status of the vehicle based on driving of the person in the driver's seat, from a driving information detector that detects the driving information; and a decision maker that, when a display device corresponding to the driver's seat is the second display device, determines whether to accept the first selection according to the driving information. When the first operation is detected, if the first selection is determined not to be accepted, the first-selection acceptor does not accept the first selection, and when the first selection is determined not to be accepted, the controller may prevent the second display device from displaying the target image.

In this way, even in situations where a person seated in a driver's seat cannot select the disapproval for outputting and displaying the image displayed on the first display device on the second display device, it is possible not to display the image on the second display device. Since it is possible to suppress the image from being unintentionally displayed on the second display device, the image displayed on the first display device can be displayed on the second display device at a more appropriate time.

Moreover, the display control device according to one aspect of the present disclosure may include: a second-setting acceptor that accepts a second setting to not accept the first selection when each of the plurality of display devices is the second display device. When the first operation is detected, if the second setting is set for a display device that is the second display device among the plurality of display devices, the first-selection acceptor does not accept the first selection, and when the second setting is set for the display device that is the second display device among the plurality of display devices, the controller may output the target image to the second display device to cause the second display device to display the target image.

In this way, when the display device with the setting to not accept the selection as to whether to approve or disapprove outputting and displaying the image displayed on the first display device on the second display device is the second display device, it is possible to output the image to the second display device and readily display the image on the second display device without the approval for outputting and displaying the image on the second display device.

Moreover, the display control device according to one aspect of the present disclosure may include: a second-operation acceptor that, when the first operation is detected, accepts, via the second display device, a second operation to output and display the target image on a third display device different from the first display device and the second display device among the plurality of display devices. When the second operation is performed, the controller may output the target image to the third display device to cause the third display device to display the target image.

In this way, it is possible to output and display the image displayed on the first display device on the third display device.

Moreover, a display control method according to one aspect of the present disclosure includes: detecting a first operation to output and display a target image on a second display device different from a first display device, the target image being an image displayed on the first display device among a plurality of display devices each of which is configured to display an image; when the first operation is detected, accepting, via the second display device, a first selection as to whether to approve or disapprove outputting and displaying the target image on the second display device; and when approval for outputting and displaying the target image on the second display device is selected, outputting and displaying the target image on the second display device.

The display control method has an advantage similar to that of the display control device described above.

Moreover, a program according to one aspect of the present disclosure is a program for causing a computer to execute the above display control method.

The program has an advantage similar to that of the display control device described above.

Hereinafter, embodiments are described in detail with reference to the drawings.

It should be noted that the embodiments described below each indicate a general or specific example. The numerical values, shapes, materials, constituent elements, arrangement and connection of the constituent elements, steps, order of steps, and other details indicated in the embodiments described below are merely examples, and do not intend to limit the present disclosure. Moreover, the constituent elements not recited in the independent claims among those described in the embodiments below are described as optional constituent elements. Moreover, the figures are schematic illustrations and are not necessarily precise depictions. Moreover, in the figures, identical constituent members are assigned the same reference sign.

### Embodiment

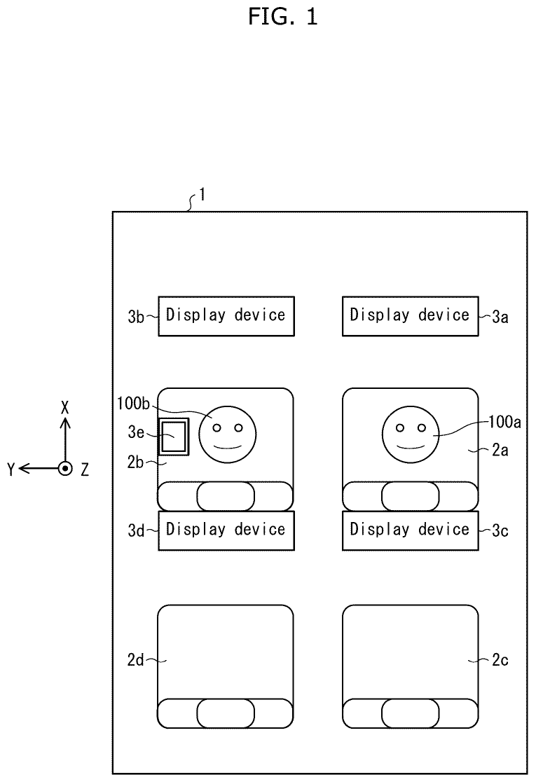

FIG. 1 is a schematic diagram of vehicle 1 provided with display control device 10 (described later) according to an embodiment. First, vehicle 1 is described with reference to FIG. 1.

In FIG. 1, an X-axis direction indicates a front-rear direction of vehicle 1, the positive side of the X-axis direction indicates the front side, and the negative side of the X-axis direction indicates the rear side. Moreover, a Y-axis direction indicates a lateral direction of vehicle 1, the positive side of the Y-axis direction indicates the left side, and the negative side of the Y-axis direction indicates the right side. Moreover, a Z-axis direction indicates a vertical direction of vehicle 1, the positive side of the Z-axis direction indicates the upper side, and the negative side of the Z-axis direction indicates the lower side.

Hereinafter, the front-rear direction of vehicle 1 may be simply referred to as the front-rear direction. Moreover, the lateral direction of vehicle 1 may be simply referred to as the lateral direction. Moreover, the vertical direction of vehicle 1 may be simply referred to as the vertical direction.

As illustrated in FIG. 1, vehicle 1 includes seats 2a to 2d and display devices 3a to 3e. For instance, vehicle 1 is, for example, an automobile.

Seat 2a is a driver's seat. Seat 2b is a front seat next to the driver's seat. Seat 2c is a right rear seat. Seat 2d is a left rear seat. Here, person 100a is seated in seat 2a, and person 100b is seated in seat 2b.

Each of display devices 3a to 3d is capable of displaying an image. Display devices 3a to 3d are arranged in vehicle 1. Display devices 3a to 3d have a one-to-one correspondence with seats 2a to 2d, and include a display device capable of displaying an image viewable by a person seated in a corresponding one of the seats. Specifically, display device 3a corresponds to seat 2a, and is capable of displaying an image viewable by person 100a seated in seat 2a. Display device 3b corresponds to seat 2b, and is capable of displaying an image viewable by person 100b seated in seat 2b. Display device 3c corresponds to seat 2c, and is capable of displaying an image viewable by a person seated in seat 2c. Display device 3d corresponds to seat 2d, and is capable of displaying an image viewable by a person seated in seat 2d. For instance, display devices 3a and 3b are located on the dashboard of vehicle 1, display device 3c is located on the headrest of seat 2a or the ceiling of vehicle 1, and display device 3d is located on the headrest of seat 2b or the ceiling of vehicle 1. Each of display devices 3a to 3d includes, for example, a touch panel display.

Display device 3e is a display device of a portable terminal. Here, display device 3e is a display device of a portable terminal of person 100b seated in seat 2b. The portable terminal is, for example, a smartphone or a tablet terminal.

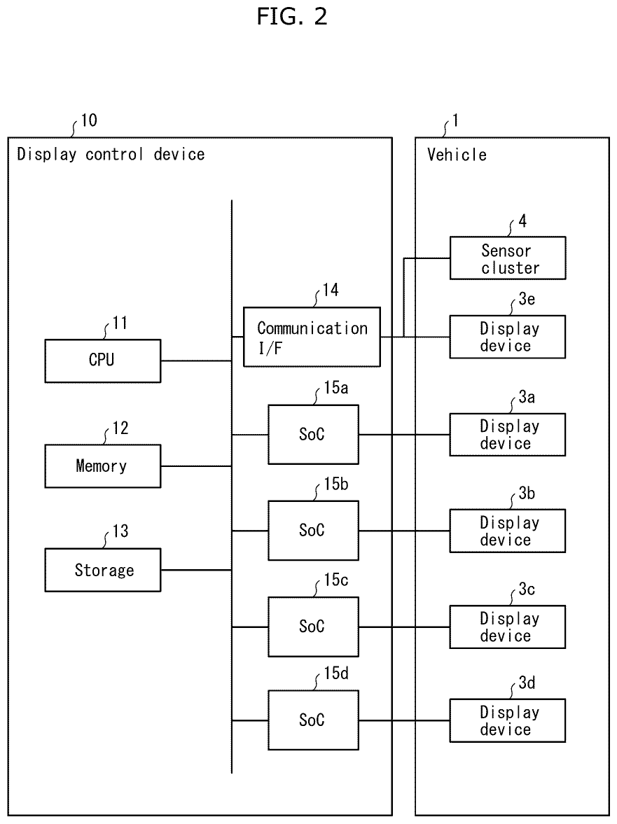

FIG. 2 is a block diagram illustrating a hardware configuration of display control device 10 and so forth in FIG. 1. Next, a hardware configuration of display control device 10 and so forth is described with reference to FIG. 2.

As illustrated in FIG. 2, vehicle 1 includes sensor cluster 4.

Sensor cluster 4 is an example of an occupancy information detector that detects occupancy information indicating whether a person is seated in each of seats 2a to 2d. For instance, sensor cluster 4 includes load sensors located at seats 2a to 2d. When a person is seated in each of seats 2a to 2d, the load sensors located at the seats detect a load greater than or equal to a predetermined load. The occupancy information includes the magnitude of a load detected by each load sensor, and indicates that a person is seated in a seat where a load greater than or equal to the predetermined load has been detected. It should be noted that the occupancy information detector may be, for example, a camera.

Sensor cluster 4 is an example of a driving information detector that detects driving information indicating a driving status of vehicle 1 based on driving of person 100a seated in seat 2a, which is the driver's seat. For instance, sensor cluster 4 includes an accelerator position sensor, a speed sensor, and an acceleration sensor. The driving information includes the amount of accelerator pedal depression in vehicle 1 detected by the accelerator position sensor. When the amount of accelerator pedal depression is greater than or equal to a predetermined amount, the driving information indicates that the driving status of vehicle 1 is a situation where vehicle 1 accelerates rapidly. Moreover, the driving information includes the speed of vehicle 1 detected by the speed sensor. When the speed is higher than or equal to a predetermined speed, the driving information indicates that the driving status of vehicle 1 is a situation where vehicle 1 is travelling at a high speed. Moreover, the driving information includes the acceleration of vehicle 1 detected by the acceleration sensor. When the acceleration in the lateral direction is higher than or equal to predetermined acceleration, the driving information indicates that the driving status of vehicle 1 is a situation where vehicle 1 is travelling along a curve.

Display control device 10 includes central processing unit (CPU) 11, memory 12, storage 13, communication interface 14, and multiple systems on chip (SoCs) 15a to 15d. These parts are communicably connected to each other.

Communication interface 14 is a communication interface to communicate with, for example, display device 3e and sensor cluster 4.

SoC 15a controls display device 3a. SoC 15b controls display device 3b. SoC 15c controls display device 3c. SoC 15d controls display device 3d.

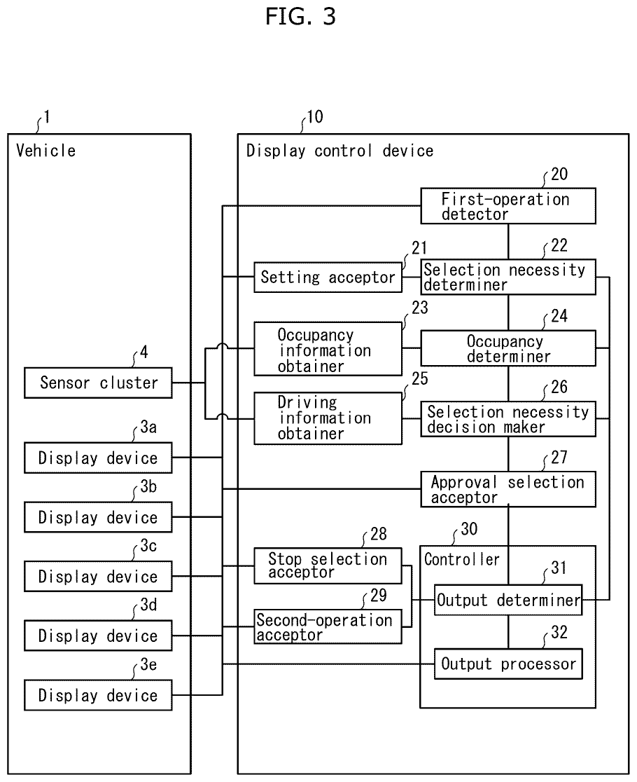

FIG. 3 is a block diagram illustrating a functional configuration of display control device 10 and so forth in FIG. 1. Next, a functional configuration of display control device 10 and so forth is described with reference to FIG. 3.

As illustrated in FIG. 3, display control device 10 includes first-operation detector 20, setting acceptor 21, selection necessity determiner 22, occupancy information obtainer 23, occupancy determiner 24, driving information obtainer 25, selection necessity decision maker 26, approval selection acceptor 27, stop selection acceptor 28, second-operation acceptor 29, and controller 30. The above elements are achieved using CPU 11, memory 12, storage 13, communication interface 14, and SoCs 15a to 15d.

First-operation detector 20 detects a first operation to output and display a target image on a second display device different from a first display device, the target image being an image displayed on the first display device among display devices 3a to 3e. For instance, when the first operation is performed, information indicating that the first operation has been performed is transmitted to first-operation detector 20. First-operation detector 20 detects the first operation by obtaining the information.

For instance, the first operation can be performed using each of display devices 3a to 3e. With regard to each of display devices 3a to 3e, when the first operation is performed using the display device, the display device transmits, to first-operation detector 20, the information indicating that the first operation has been performed. The first display device is a display device on which the first operation has been performed, among display devices 3a to 3e. The second display device is determined from among display devices 3a to 3e by the first operation. Specifically, using display device 3a, person 100a seated in seat 2a performs the first operation to output and display, on display device 3b, an image displayed on display device 3a. In this case, the information indicating that the first operation has been performed is transmitted from display device 3a to first-operation detector 20. Then, first-operation detector 20 obtains the information and detects the first operation. In this case, display device 3a is the first display device, and display device 3b is the second display device.

The first operation may be an operation to display the entire target image on the second display device, and may be an operation to display the target image across the first display device and the second display device by displaying a part of the target image on the second display device. Moreover, the first operation may be an operation to move the target image to the second display device, an operation to copy the target image to the second display device, and an operation to mirror the target image to the second display device. Moreover, when the target image is an application image, a permission to operate an application may be given to a person seated in a seat corresponding to the second display device, by enabling the person to operate the application using the second display device. Moreover, when the target image is an application image, a permission to operate an application may be shared by a person seated in a seat corresponding to the first display device and a person seated in a seat corresponding to the second display device, by enabling the persons to operate the application regardless of whether the first display device or the second display device is used.

Setting acceptor 21 is an example of a first-setting acceptor that accepts a first setting. The first setting is a setting to prevent the second display device from displaying the target image in the following situation: neither approval nor disapproval for outputting and displaying the target image on the second display device is selected within a predetermined period from the start of acceptance of a first selection as to whether to approve or disapprove outputting and displaying the target image on the second display device. That is, when the first setting is set, if neither the approval or the disapproval for outputting and displaying the target image on the second display device is selected within the predetermined period from the start of acceptance of the first selection, the target image will not be displayed on the second display device.

For instance, setting acceptor 21 can cause each of display devices 3a to 3e to display a first-setting screen on which to set the first setting, and accepts the first setting via the first-setting screen displayed on each display device. Specifically, person 100a seated in seat 2a can open the first-setting screen by operating display device 3a, and sets the first setting via the first-setting screen displayed on display device 3a. In this case, the first setting may be applied only when display device 3a is the second display device or may be applied when each of display devices 3a to 3e is the second display device.

It should be noted that instead of the first setting, a setting for the second display device to display the target image may be set in the following situation: neither the approval or the disapproval for outputting and displaying the target image on the second display device is selected within the predetermined period from the start of acceptance of the first selection as to whether to approve or disapprove outputting and displaying the target image on the second display device. Moreover, whether to set the above setting or to set the first setting may be selected for each of display devices 3a to 3e.

Moreover, setting acceptor 21 is an example of a second-setting acceptor that accepts a second setting. The second setting is a setting to not accept the first selection when each of display devices 3a to 3e is the second display device. That is, when a display device with the second setting among display devices 3a to 3e is the second display device, the first selection will not be accepted.

For instance, setting acceptor 21 is capable of causing each of display devices 3a to 3e to display a second-setting screen on which to set the second setting, and accepts the second setting via the second-setting screen displayed on each display device. Specifically, person 100a seated in seat 2a can open the second-setting screen by operating display device 3a, and sets the second setting via the second-setting screen displayed on display device 3a. In this case, the second setting may be set only for display device 3a or may be set for each of display devices 3a to 3e. By setting the second setting for display device 3a, when display device 3a is the second display device, it is possible not to accept the first selection.

Selection necessity determiner 22 determines whether it is necessary to accept the first selection as to whether to approve or disapprove outputting and displaying the target image on the second display device. For instance, selection necessity determiner 22 identifies the second display device from the first operation detected by first-operation detector 20. When the second setting is set for the second display device, selection necessity determiner 22 determines that the first selection is not necessary. When the second setting is not set for the second display device, selection necessity determiner 22 determines that the first operation is necessary.

Occupancy information obtainer 23 obtains occupancy information detected by sensor cluster 4. Occupancy information obtainer 23 may obtain the occupancy information regularly or every time first-operation detector 20 detects the first operation.

According to the occupancy information, occupancy determiner 24 determines whether a person is seated in each of seats 2a to 2d. For instance, when the occupancy information indicates that person 100a is seated in seat 2a, occupancy determiner 24 determines that person 100a is seated in seat 2a.

Driving information obtainer 25 obtains driving information detected by sensor cluster 4. Driving information obtainer 25 may obtain the driving information regularly or every time first-operation detector 20 detects the first operation.

Selection necessity decision maker 26 determines whether to accept the first selection as to whether to approve or disapprove outputting and displaying the target image on the second display device.

For instance, when a person is not seated in a seat corresponding to the second display device, selection necessity decision maker 26 determines that the first selection is not to be accepted.

Moreover, when display device 3a corresponding to seat 2a, which is the driver's seat, is the second display device, selection necessity decision maker 26 determines whether to accept the first selection, according to the driving information. For instance, if the driving information indicates a driving status where the approval or the disapproval for outputting and displaying the target image on the second display device can be selected, selection necessity decision maker 26 determines that the first selection is to be accepted. Meanwhile, if the driving information indicates a driving status where the approval or the disapproval for outputting and displaying the target image on the second display device cannot be selected, selection necessity decision maker 26 determines that the first selection is not to be accepted. Specifically, when the driving status of vehicle 1 is a situation where vehicle 1 accelerates rapidly, selection necessity decision maker 26 determines that the first selection is not to be accepted. Moreover, when the driving status of vehicle 1 is a situation where vehicle 1 is travelling at a high speed, selection necessity decision maker 26 determines that the first selection is not to be accepted. Moreover, when the driving status of vehicle 1 is a situation where vehicle 1 is travelling along a curve, selection necessity decision maker 26 determines that the first selection is not to be accepted.

When first-operation detector 20 detects the first operation, approval selection acceptor 27 accepts, via the second display device, the first selection as to whether to approve or disapprove outputting and displaying the target image on the second display device.

For instance, approval selection acceptor 27 accepts the first selection as a result of causing the second display device to display (i) options as to whether to approve or disapprove outputting and displaying the target image on the second display device or (ii) a thumbnail of the target image. Whether the options or the thumbnail is displayed is preset according to, for example, persons seated in seats 2a to 2d. It should be noted that approval selection acceptor 27 may accept the first selection by sound, may accept the first selection as a result of causing the second display device to display an icon, and may accept the first selection as a result of causing the second display device to display an animation. Moreover, approval selection acceptor 27 may vibrate the second display device when accepting the first selection. Moreover, approval selection acceptor 27 may combine the above methods to accept the first selection.

Approval selection acceptor 27 determines a position at which to display the options or the thumbnail on the second display device, according to the position of the first display device relative to the second display device, and causes the options or the thumbnail to be displayed at the determined position. For instance, when the first display device is located ahead of the second display device in the front-rear direction, approval selection acceptor 27 causes the options or the thumbnail to be displayed at an upper portion of the display screen of the second display device. Moreover, when the first display device is located to the left of the second display device in the lateral direction, approval selection acceptor 27 causes the options or the thumbnail to be displayed at a left portion of the display screen of the second display device. For instance, a one-to-one correspondence between display devices 3a to 3d and seats 2a to 2d is preregistered. Approval selection acceptor 27 identifies positional relationships from the registered information. Moreover, display device 3e and vehicle 1 are each provided with, for example, a global positioning system (GPS). Approval selection acceptor 27 identifies positional relationships between display device 3e and display devices 3a to 3d from position information on display device 3e and position information on vehicle 1.

When first-operation detector 20 detects the first operation, if selection necessity decision maker 26 determines that the first selection is not to be accepted, approval selection acceptor 27 will not accept first selection. For instance, when first-operation detector 20 detects the first operation, if a person is not seated in a seat corresponding to the second display device, approval selection acceptor 27 will not accept the first selection. Moreover, when first-operation detector 20 detects the first operation, if the second setting is set for a display device that is the second display device among display devices 3a to 3e, approval selection acceptor 27 will not accept the first selection.

Stop selection acceptor 28 is an example of a second-selection acceptor that, when first-operation detector 20 detects the first operation, accepts, via the first display device, a second selection as to whether to stop outputting and displaying the target image on the second display device.

For instance, stop selection acceptor 28 accepts the second selection as a result of causing the first display device to display options as to whether to stop outputting and displaying the target image on the second display device. It should be noted that stop selection acceptor 28 may accept the second selection before the selection of approval for outputting and displaying the target image on the second display device, and may accept the second selection after the selection of approval for outputting and displaying the target image on the second display device.

When first-operation detector 20 detects the first operation, second-operation acceptor 29 accepts, via the second display device, a second operation to output and display the target image on a third display device different from the first display device and the second display device among display devices 3a to 3e.

For instance, second-operation acceptor 29 accepts the second operation as a result of causing the second display device to display options as to whether to approve or disapprove outputting and displaying the target image on the third display device. It should be noted that second-operation acceptor 29 may accept the second operation by sound, may accept the second operation as a result of causing the second display device to display an icon, and may accept the second operation as a result of causing the second display device to display an animation. Moreover, second-operation acceptor 29 may vibrate the second display device when accepting the second operation. Moreover, second-operation acceptor 29 may combine the above methods to accept the second operation. Moreover, the second operation may be accepted before the acceptance of the first selection, after the acceptance of the first selection, or at the same time as acceptance of the first selection.

The second operation may be an operation to display the entire target image on the third display device, and may be an operation to display the target image across the second display device and the third display device by displaying a part of the target image on the third display device. Moreover, the second operation may be an operation to move the target image to the third display device, an operation to copy the target image to the third display device, and an operation to mirror the target image to the third display device.

Controller 30 includes output determiner 31 and output processor 32.

Output determiner 31 determines whether the approval for outputting and displaying the target image on the second display device has been selected in the first selection accepted by approval selection acceptor 27. When the approval for outputting and displaying the target image on the second display device is selected, output processor 32 outputs the target image to the second display device to cause the second display device to display the target image.

Specifically, output determiner 31 determines whether an approval option for outputting and displaying the target image on the second display device has been selected from the options as to whether to approve or disapprove outputting and displaying the target image on the second display device, or determines whether the thumbnail has been tapped. When the approval option for outputting and displaying the target image on the second display device is selected from the options, or when the thumbnail is tapped, output processor 32 outputs the target image to the second display device to cause the second display device to display the target image.

Moreover, output determiner 31 determines whether the disapproval for outputting and displaying the target image on the second display device has been selected in the first selection accepted by approval selection acceptor 27. When the disapproval for outputting and displaying the target image on the second display device is selected, output processor 32 prevents the second display device from displaying the target image.

Specifically, output determiner 31 determines whether a disapproval option for outputting and displaying the target image on the second display device has been selected from the options as to whether to approve or disapprove outputting and displaying the target image on the second display device. When the disapproval option for outputting and displaying the target image on the second display device is selected from the options, output processor 32 prevents the target image from being output to or displayed on the second display device.

Moreover, output determiner 31 determines whether the first setting is set. Output processor 32 prevents the second display device from displaying the target image when the first setting is set in the following situation: neither the approval nor the disapproval for outputting and displaying the target image on the second display device is selected within the predetermined period from the start of acceptance of the first selection by approval selection acceptor 27.

Moreover, output determiner 31 determines whether to stop outputting and displaying the target image on the second display device has been selected. If to stop outputting and displaying the target image on the second display device is selected, output processor 32 stops the target image from being output to and displayed on the second display device. For instance, if to stop outputting and displaying the target image on the second display device is selected after the target image is output to and displayed on the second display device, output processor 32 causes the second display device to display, instead of the target image, an image that had been displayed on the second display device before the target image was displayed on the second display device.

Moreover, output determiner 31 determines whether a person is seated in a seat corresponding to the second display device. When a person is not seated in the seat corresponding to the second display device, output processor 32 will output the target image on the second display device to cause the second display device to display the target image.

Moreover, output determiner 31 determines whether selection necessity decision maker 26 has determined that the first selection is not to be accepted, according to the driving information. When selection necessity decision maker 26 determines that the first selection is not to be accepted, according to the driving information, output processor 32 prevents the second display device from displaying the target image.

Moreover, output determiner 31 determines whether the second setting is set for a display device that is the second display device among display devices 3a to 3e. When the second setting is set for the display device that is the second display device among display devices 3a to 3e, output processor 32 outputs the target image to the second display device to cause the second display device to display the target image.

Moreover, output determiner 31 determines whether the second operation has been performed. When the second operation is performed, output processor 32 outputs the target image to the third display device to cause the third display device to display the target image.

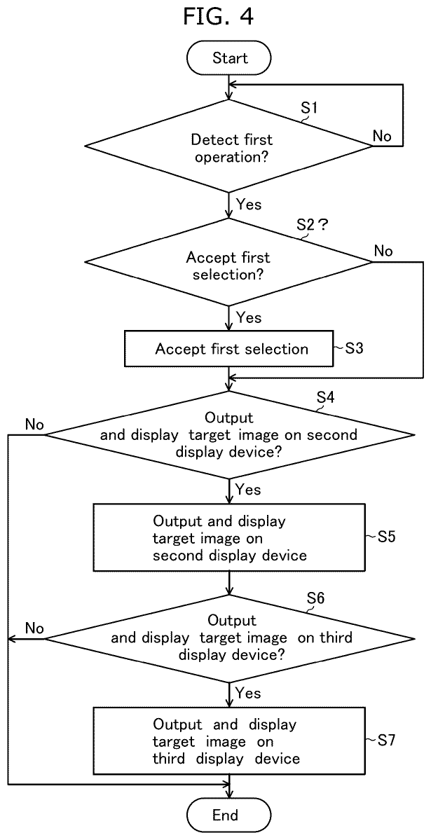

FIG. 4 is a flowchart illustrating an example of a display control method performed by display control device 10 in FIG. 1. Next, an example of the display control method performed by display control device 10 in FIG. 1 is described with reference to FIG. 4.

As illustrated in FIG. 4, first-operation detector 20 determines whether the first operation has been detected (step S1).

When the first operation is not detected (No in step S1), first-operation detector 20 redetermines whether the first operation has been detected (step S1).

When the first operation is detected (first-operation detection step) (Yes in step S1), approval selection acceptor 27 determines whether to accept the first selection (step S2). As described above, for instance, when a person is not seated in a seat corresponding to the second display device, approval selection acceptor 27 determines that the first selection is not to be accepted.

When accepting the first selection (Yes in step S2), approval selection acceptor 27 will accept the first selection (first-selection acceptance step) (step S3).

When the first selection is not accepted (No in step S2), controller 30 determines whether to output and display the target image on the second display device (step S4). Moreover, when the first selection is accepted (step S3), controller 30 determines whether to output and display the target image on the second display device (step S4). As described above, for instance, when approval for outputting and displaying the target image on the second display device is selected, controller 30 determines that the target image is to be displayed on the second display device. Meanwhile, for instance, when disapproval for outputting and displaying the target image on the second display device is selected, controller 30 determines that the target image is not to be displayed on the second display device.

When the target image is determined to be output to and displayed on the second display device (Yes in step S4), controller 30 outputs the target image to the second display device to cause the second display device to display the target image (control step) (step S5).

Controller 30 determines whether the target image is to be output to and displayed on the third display device (step S6). As described above, when the second operation is performed, controller 30 determines that the target image is to be output to and displayed on the third display device.

When determining that the target image is to be output to and displayed on the third display device (Yes in step S6), controller 30 outputs the target image to the third display device to cause the third display device to display the target image (step S7).

When determining that the target image is not to be output to or displayed on the second display device (No in step S4), controller 30 ends the processing without causing the second display device to display the target image.

Moreover, when determining that the target image is not to be output to or displayed on the third display device (No in step S6), controller 30 ends the processing without causing the third display device to display the target image.

It should be noted that after the first operation is detected (after step S1), stop selection acceptor 28 accepts the second selection. In the second selection, if to stop outputting and displaying the target image on the second display device is selected, the subsequent processing of step S2 is stopped.

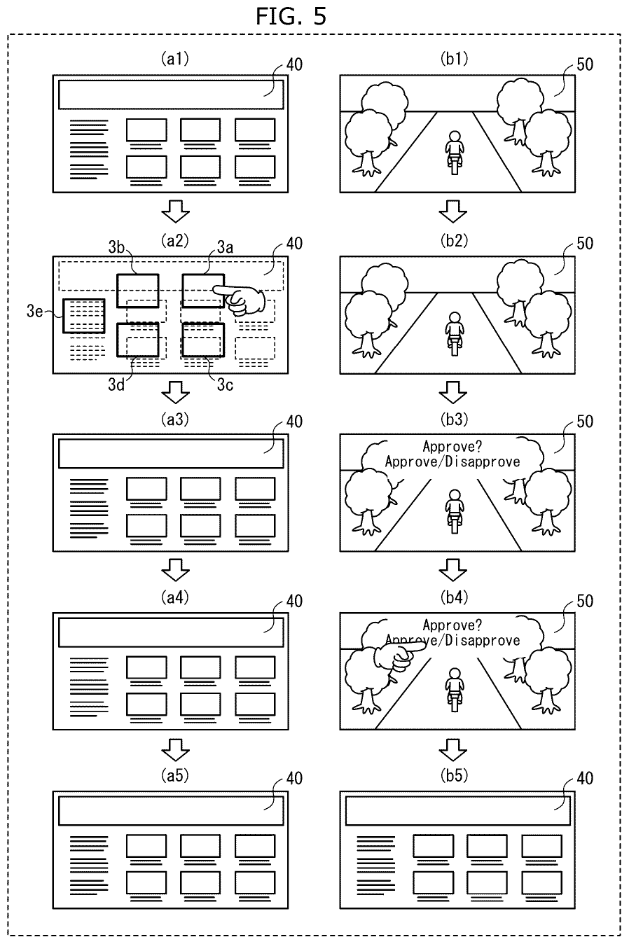

FIGS. 5 to 12 are figures for explaining first to eighth operation examples of display control device 10 in FIG. 1. Next, the first to eighth operation examples of display control device 10 are described with reference to FIGS. 5 to 12.

First, the first operation example is described with reference to FIGS. 5. (a1) to (a5) in FIG. 5 illustrate the first display device, and (b1) to (b5) in FIG. 5 illustrate the second display device.

As illustrated in (a1) in FIG. 5, the first display device is displaying image 40. As illustrated in (b1) in FIG. 5, the second display device is displaying image 50.

As illustrated in (a2) in FIG. 5, by operating the first display device, the icons of display devices 3a to 3e are displayed on the first display device. By tapping one of the displayed icons of display devices 3a to 3e, the second display device is selected, and the first operation is performed. Here, although the icons of display devices 3a to 3e are displayed, the icon of a display device on which the first operation will be performed need not be displayed.

As illustrated in (b3) in FIG. 5, when the first operation is performed, the second display device displays options as to whether to approve or disapprove outputting and displaying image 40 that is the target image on the second display device. In this way, the first selection is accepted.

As illustrated in (b4) in FIG. 5, between the options as to whether to approve or disapprove outputting and displaying image 40 on the second display device, when “Approve” that is an approval option for outputting and displaying image 40 on the second display device is tapped, image 40 is output to and displayed on the second display device as illustrated in (b5) in FIG. 5.

Here, image 40 is copied to the second display device. It should be noted that image 40 may be mirrored to the second display device. That is, the first operation is an operation to copy or mirror image 40 to the second display device. It should be noted that for copying, the first display device and the second display device can be, for example, operated independently from each other, using image 40. For mirroring, in response to an operation and so forth using image 40 performed on the first display device, the operation and so forth using image 40 is performed in the same manner on the second display device.

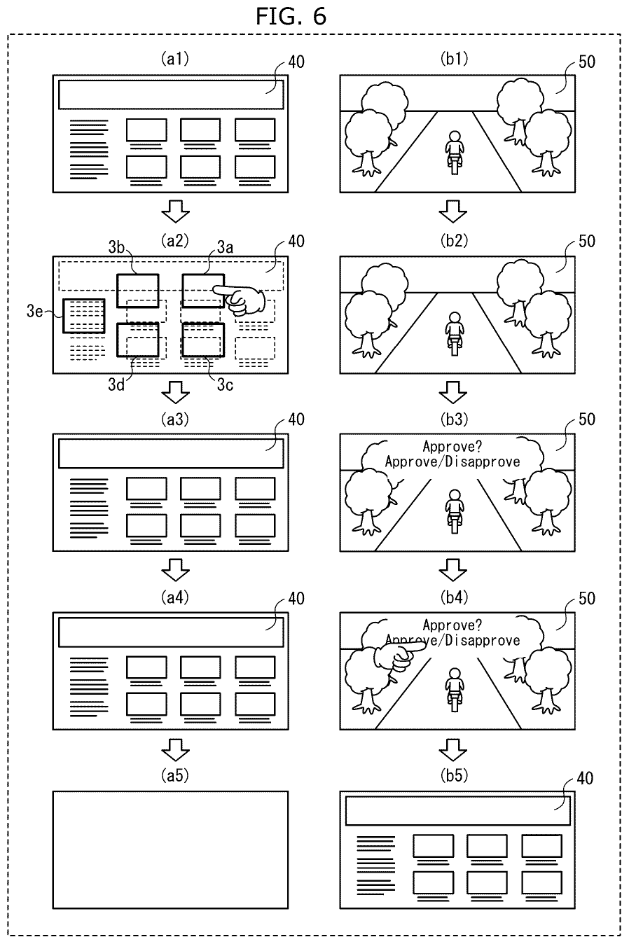

Next, the second operation example is described with reference to FIGS. 6. (a1) to (a5) in FIG. 6 illustrate the first display device, and (b1) to (b5) in FIG. 6 illustrate the second display device.

The second operation example differs from the first operation example mainly in the following points.

As illustrated in (a5) and (b5) in FIG. 6, here, image 40 is moved to the second display device, and image 40 is not displayed on the first display device. That is, the first operation is an operation to move image 40 to the second display device. It should be noted that after image 40 is moved to the second display device, another image may be displayed on the first display device.

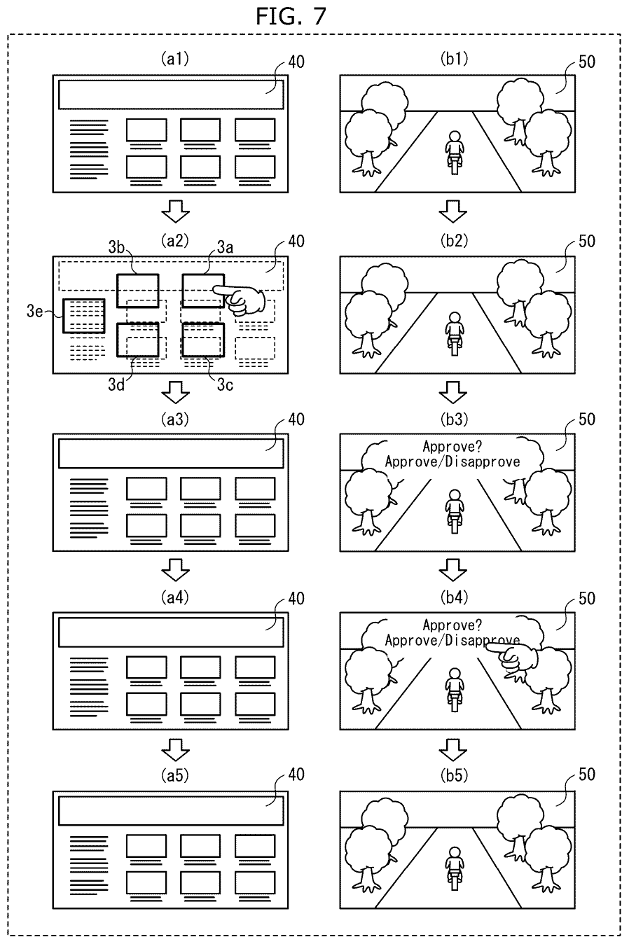

Next, the third operation example is described with reference to FIGS. 7. (a1) to (a5) in FIG. 7 illustrate the first display device, and (b1) to (b5) in FIG. 7 illustrate the second display device.

The third operation example differs from the first operation example mainly in the following points.

As illustrated in (b4) in FIG. 7, here, between options as to whether to approve or disapprove outputting and displaying image 40 on the second display device, “Disapprove” that is a disapproval option for outputting and displaying image 40 on the second display device is tapped. Thus, as illustrated in (b5) in FIG. 7, image 40 is not displayed on the second display device, and image 50 is still displayed on the second display device.

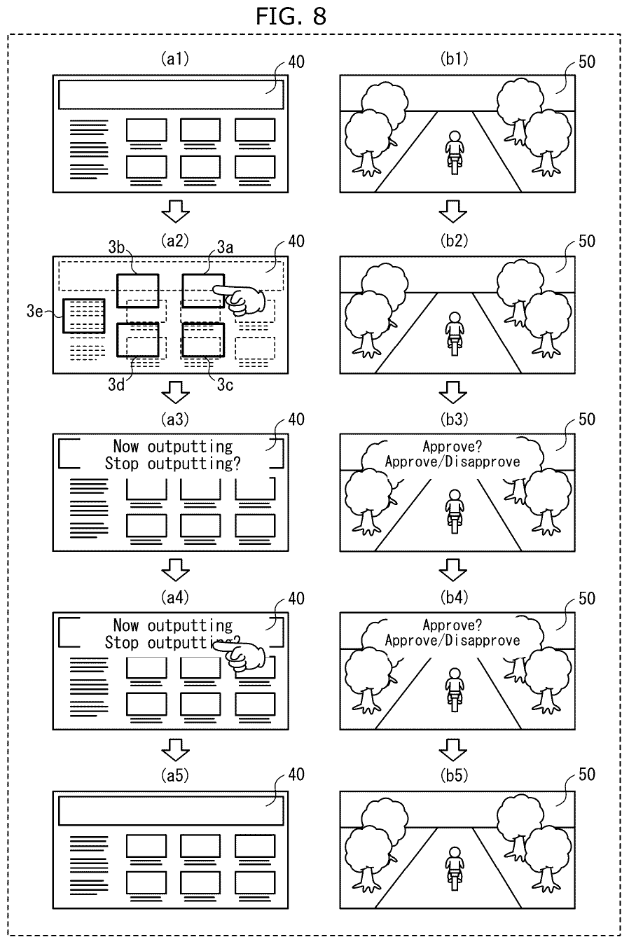

Next, the fourth operation example is described with reference to FIGS. 8. (a1) to (a5) in FIG. 8 illustrate the first display device, and (b1) to (b5) in FIG. 8 illustrate the second display device.

The fourth operation example differs from the first operation example mainly in the following points.

As illustrated in (a3) in FIG. 8, here, the second selection as to whether to stop outputting and displaying image 40 on the second display device is accepted.

As illustrated in (a4) in FIG. 8, when a message as to whether to stop outputting and displaying image 40 on the second display device is tapped, outputting and displaying image 40 on the second display device is stopped. Thus, as illustrated in (b5) in FIG. 8, image 40 is not displayed on the second display device, and image 50 is still displayed on the second display device.

It should be noted that outputting and displaying image 40 on the second display device may be stopped before the selection of the approval for outputting and displaying image 40 on the second display device. Outputting and displaying image 40 on the second display device may be stopped after the selection of the approval for outputting and displaying image 40 on the second display device.

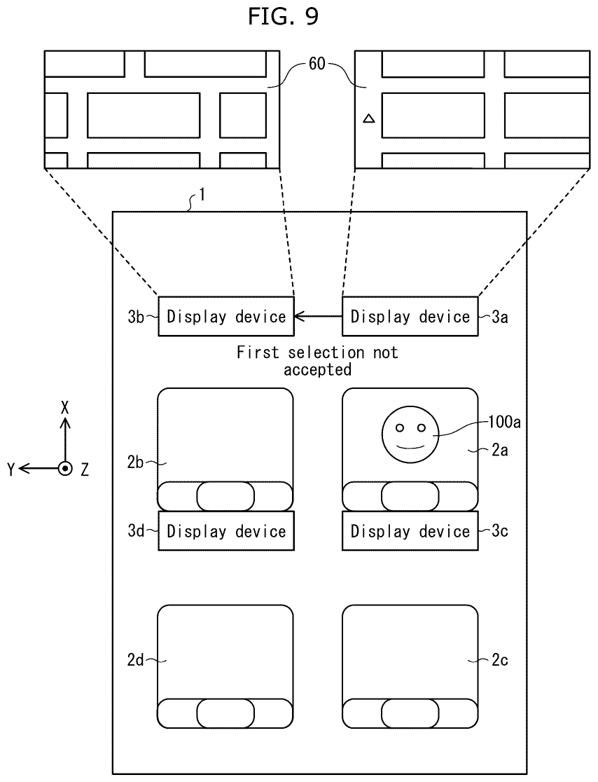

Next, the fifth operation example is described with reference to FIG. 9.

As illustrated in FIG. 9, here, display device 3a is the first display device, and display device 3b is the second display device.

Since no one is seated in seat 2b corresponding to display device 3b, image 60 displayed on display device 3a is output to and displayed on display device 3b without the first selection being accepted.

It should be noted that here, the first operation is an operation to output and display a part of image 60 on display device 3b, and image 60 is displayed across display device 3a and display device 3b.

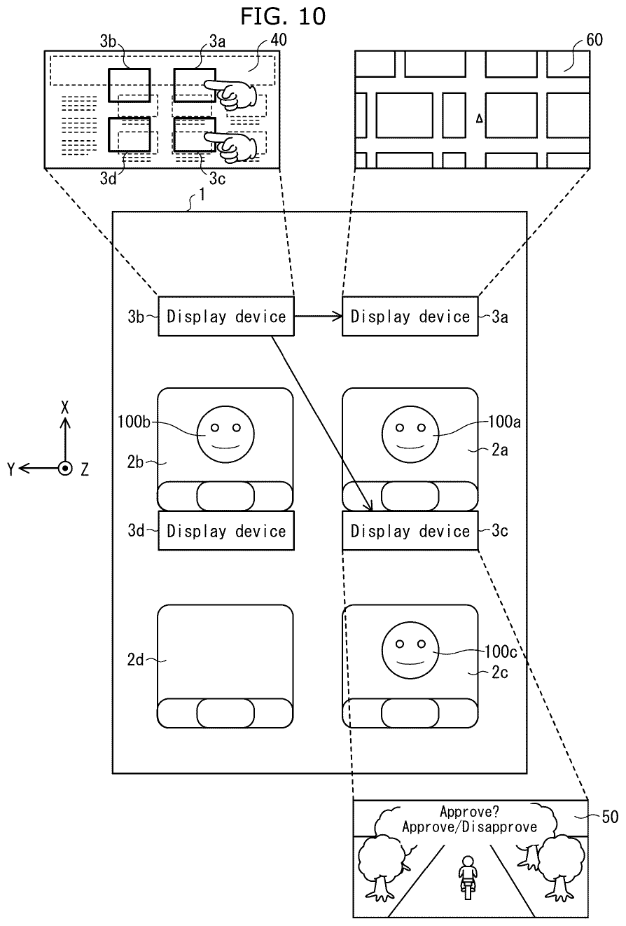

Next, the sixth operation example is described with reference to FIG. 10.

As illustrated in FIG. 10, here, display device 3b is the first display device, and each of display device 3a and display device 3c is the second display device.

It is determined that the first selection is not to be accepted for display device 3a, from the driving status of vehicle 1 based on driving of person 100a seated in seat 2a corresponding to display device 3a. Image 40 will not be displayed on display device 3a.

When person 100c is seated in seat 2c corresponding to display device 3c, the first selection is accepted for display device 3c, and outputting and displaying image 40 on display device 3c is approved, image 40 will be displayed on display device 3c.

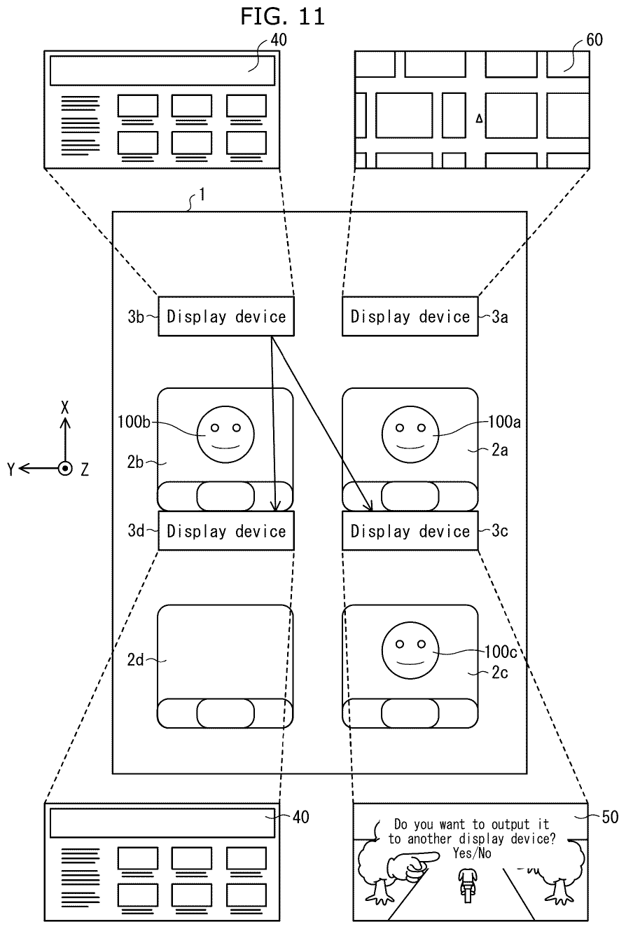

Next, the seventh operation example is described with reference to FIG. 11.

As illustrated in FIG. 11, here, display device 3b is the first display device, display device 3c is the second display device, and display device 3d is the third display device.

As a result of causing display device 3c to display options as to whether to output image 40 to another display device (the third display device), the second operation to output and display image 40 on the above display device is accepted via display device 3c. Here, display device 3d is preset as another display device. It should be noted that another display device may be selected via display device 3c. Between options as to whether to output image 40 to another display device, when “Yes” that means to output image 40 is tapped, the second operation will be performed, and image 40 will be displayed on display device 3d. It should be noted that here, since displaying image 40 on display device 3c was not approved in the first selection, image 40 will not be displayed on display device 3c.

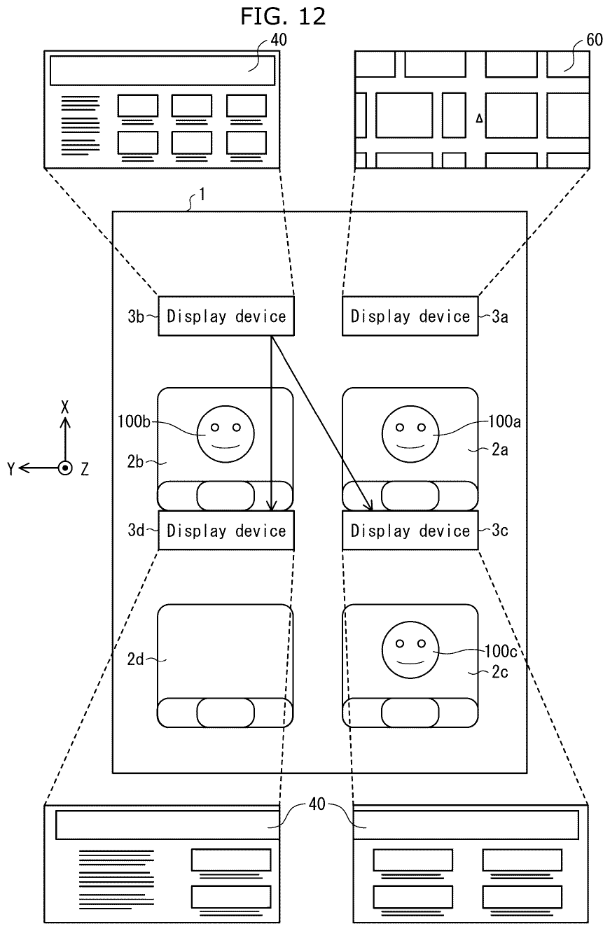

Next, the eighth operation example is described with reference to FIG. 12.

As illustrated in FIG. 12, here, display device 3b is the first display device, display device 3c is the second display device, and display device 3d is the third display device.

The second operation to output image 40 to display device 3d was performed on display device 3c, and image 40 is displayed on display device 3d. It should be noted that here, the second operation is an operation to output and display a part of image 40 on display device 3d, and image 40 is displayed across display device 3c and display device 3d.

Display control device 10 according to the embodiment includes: first-operation detector 20 that detects a first operation to output and display a target image on a second display device different from a first display device, the target image being an image displayed on the first display device among display devices 3a to 3e each of which is configured to display an image; approval selection acceptor 27 that, when the first operation is detected, accepts, via the second display device, a first selection as to whether to approve or disapprove outputting and displaying the target image on the second display device; and controller 30 that outputs the target image to the second display device to cause the second display device to display the target image when approval for outputting and displaying the target image on the second display device is selected.

In this way, when the approval for outputting and displaying the image displayed on the first display device on the second display device is selected, it is possible to display the image on the second display device. Since it is possible to suppress the image from being unintentionally displayed on the second display device, the image displayed on the first display device can be displayed on the second display device at a more appropriate time.

Moreover, in display control device 10 according to the embodiment, when disapproval for outputting and displaying the target image on the second display device is selected, controller 30 prevents the second display device from displaying the target image.

In this way, when the disapproval for outputting and displaying the image displayed on the first display device on the second display device is selected, it is possible not to display the image on the second display device. Since it is possible to suppress the image from being unintentionally displayed on the second display device, the image displayed on the first display device can be displayed on the second display device at a more appropriate time.

Moreover, display control device 10 according to the embodiment includes setting acceptor 21 that accepts a first setting to prevent the second display device from displaying the target image, in a situation where neither the approval nor disapproval for outputting and displaying the target image on the second display device is selected within a predetermined period from the start of acceptance of the first selection. Controller 30 prevents the second display device from displaying the target image when the first setting is set in the situation where neither the approval nor the disapproval for outputting and displaying the target image on the second display device is selected within the predetermined period.

In this way, even if the disapproval for outputting and displaying the image displayed on the first display device on the second display device is not selected within the predetermined period, it is possible not to display the image on the second display device. Since it is possible to suppress the image from being unintentionally displayed on the second display device, the image displayed on the first display device can be displayed on the second display device at a more appropriate time.

Moreover, display control device 10 according to the embodiment includes stop selection acceptor 28 that, when the first operation is detected, accepts, via the first display device, a second selection as to whether to stop outputting and displaying the target image on the second display device. If to stop outputting and displaying the target image on the second display device is selected, controller 30 stops the target image from being output to and displayed on the second display device.

In this way, even when the disapproval for outputting and displaying the image displayed on the first display device on the second display device is not selected, by selecting to stop outputting and displaying the image on the second display device, it is possible not to display the image on the second display device. Since it is possible to suppress the image from being unintentionally displayed on the second display device, the image displayed on the first display device can be displayed on the second display device at a more appropriate time.

Moreover, in display control device 10 according to the embodiment, approval selection acceptor 27 accepts a first selection as a result of causing the second display device to display (i) options as to whether to approve or disapprove outputting and displaying the target image on the second display device or (ii) a thumbnail of the target image. When an approval option for outputting and displaying the target image on the second display device is selected from the options, or when the thumbnail is tapped, controller 30 outputs the target image to the second display device to cause the second display device to display the target image.

In this way, using the options or thumbnail, it is possible to easily select the approval or the disapproval for outputting and displaying the image displayed on the first display device on the second display device.

Moreover, in display control device 10 according to the embodiment, approval selection acceptor 27 determines a position at which to display the options or the thumbnail on the second display device according to the position of the first display device relative to the second display device, and causes the options or the thumbnail to be displayed at the determined position.

In this way, the position of the first display device can be estimated from the position of the options or the thumbnail. Thus, it is possible to readily estimate which display device's image, among the images of display devices 3a to 3e, will be output.

Moreover, in display control device 10 according to the embodiment, display devices 3a to 3e include display devices 3a to 3d that have a one-to-one correspondence with seats 2a to 2d in vehicle 1 including seats 2a to 2d, and are each configured to display an image viewable by a person seated in a corresponding one of seats 2a to 2d. Display control device 10 includes: occupancy information obtainer 23 that obtains occupancy information indicating whether a person is seated in each of seats 2a to 2d, from sensor cluster 4 that detects the occupancy information; and occupancy determiner 24 that determines whether a person is seated in each of seats 2a to 2d according to the occupancy information. When the first operation is detected, if a person is not seated in a seat corresponding to the second display device, approval selection acceptor 27 does not accept the first selection. When a person is not seated in the seat corresponding to the second display device, controller 30 outputs the target image to the second display device to cause the second display device to display the target image.

In this way, when a person is not seated in the seat corresponding to the second display device, the image displayed on the first display device can be readily output to and displayed on the second display device without the approval for outputting and displaying the image displayed on the first display device on the second display device.

Moreover, in display control device 10 according to the embodiment, display devices 3a to 3e include display devices 3a to 3d that have a one-to-one correspondence with seats 2a to 2d in vehicle 1 including seats 2a to 2d among which seat 2a is a driver's seat, and are each configured to display an image viewable by a person seated in a corresponding one of seats 2a to 2d. Display control device 10 includes: driving information obtainer 25 that obtains driving information indicating a driving status of vehicle 1 based on driving of a person seated in seat 2a from sensor cluster 4 that detects the driving information; and selection necessity decision maker 26 that, when display device 3a corresponding to seat 2a is the second display device, determines whether to accept the first selection according to the driving information. When the first operation is detected, if the first selection is determined not to be accepted, approval selection acceptor 27 does not accept the first selection. When the first selection is determined not to be accepted, controller 30 prevents the second display device from displaying the target image.

As such, even in situations where the person seated in seat 2a cannot select the disapproval for outputting and displaying the image displayed on the first display device on the second display device, it is possible not to display the image on the second display device. Since it is possible to suppress the image from being unintentionally displayed on the second display device, the image displayed on the first display device can be displayed on the second display device at a more appropriate time.

Moreover, display control device 10 according to the embodiment includes setting acceptor 21 that accepts a second setting to not accept the first selection when each of display devices 3a to 3e is the second display device. When the first operation is detected, if the second setting is set for a display device that is the second display device among display devices 3a to 3e, approval selection acceptor 27 does not accept the first selection. When the second setting is set for the display device that is the second display device among display devices 3a to 3e, controller 30 outputs the target image to the second display device to cause the second display device to display the target image.

In this way, when the display device with the setting to not accept selection as to whether to approve or disapprove outputting and displaying the image displayed on the first display device on the second display device is the second display device, it is possible to output the image to the second display device and readily display the image on the second display device without the approval for outputting and displaying the image on the second display device.

Moreover, display control device 10 according to the embodiment includes second-operation acceptor 29 that, when the first operation is detected, accepts, via the second display device, a second operation to output and display the target image on a third display device different from the first display device and the second display device among display devices 3a to 3e. When the second operation is performed, controller 30 outputs the target image to the third display device to cause the third display device to display the target image.

In this way, the image displayed on the first display device can be displayed on the third display device.

Moreover, a display control method according to the embodiment includes: detecting a first operation to output and display a target image on a second display device different from a first display device, the target image being an image displayed on the first display device among display devices 3a to 3e each of which is configured to display an image (step S1); when the first operation is detected, accepting, via the second display device, a first selection as to whether to approve or disapprove outputting and displaying the target image on the second display device (step S3); and when approval for outputting and displaying the target image on the second display device is selected, outputting and displaying the target image on the second display device (step S5).

The display control method has an advantage similar to that of display control device 10 described above.

Moreover, a program according to the embodiment is a program for causing a computer to execute the display control method described above.

The program has an advantage similar to that of display control device 10 described above.

While an embodiment has been described herein above, it is to be appreciated that various changes in form and detail may be made without departing from the spirit and scope of the present disclosure as presently or hereafter claimed.

### OTHER EMBODIMENTS

The display control device and so forth according to one or more aspects are described above on the basis of the embodiment. However, the present disclosure is not limited to the embodiment. The scope of the present disclosure may also encompass embodiments obtained by adding, to the embodiment, various modifications envisioned by those skilled in the art as long as the resultant embodiments do not depart from the scope of the present disclosure.

In the above embodiment, cases where display devices 3a to 3e include display devices 3a to 3d located in vehicle 1 are described as non-limiting examples. For instance, the plurality of display devices need not include display devices located in vehicle 1, and the plurality of display devices may be the display devices of, for example, portable terminals.

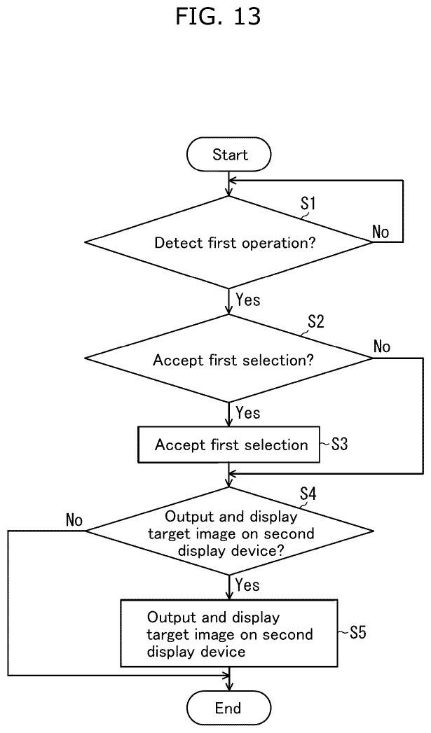

Moreover, in the above embodiment, a case where the third display device is present is described as a non-limiting example. For instance, the plurality of display devices are two display devices, and the third display device need not be present. FIG. 13 is a flowchart illustrating another example of the display control method performed by display control device 10 in FIG. 1. As illustrated in FIG. 13, for instance, when the third display device is not present, display control device 10 need not perform step S6 or step S7 among steps S1 to S7 described above. It should be noted that display control device 10 may determine whether to perform steps S6 and S7 according to, for example, the arrangement of the plurality of display devices and/or a seating status for each of the plurality of seats. When steps S6 and S7 are determined to be performed, display control device 10 may perform the display control method displayed in FIG. 4. When steps S6 and S7 are determined not to be performed, display control device 10 may perform the display control method displayed in FIG. 13.

It should be noted that in the embodiment, each constituent element may be achieved as dedicated hardware or may be achieved by executing a software program suitable for the constituent element. Each constituent element may be achieved by a program executer, such as a CPU or a processor, reading out and executing a software program stored in a recording medium, such as a hard disk or semiconductor memory. Here, software to achieve the device and so forth described in the above embodiment is a program for causing a computer to perform the steps included in the flowcharts illustrated in FIGS. 4 and 13.

It should be noted that the present disclosure also encompasses the following cases.
(1) Each device described above is, specifically, a computer system including, for example, a microprocessor, ROM, RAM, a hard disk unit, a display unit, a keyboard, and a mouse. A computer program is stored in the RAM or hard disk unit. The functions of each device are achieved by the microprocessor operating in accordance with the computer program. Here, the computer program is constructed by combining two or more instruction codes to command a computer to achieve a predetermined function.
(2) Some or all of constituent elements included in each device described above may be configured as a single system large scale integration (LSI). A system LSI is a super multifunctional LSI manufactured by integrating parts into one chip, and specifically a computer system including a microprocessor, ROM, and RAM. A computer program is stored in the RAM. The functions of the system LSI are achieved by the microprocessor operating in accordance with the computer program.
(3) Some or all of the constituent elements included in each device described above may be configured as an IC card or a single module detachable from and attachable to the device. The IC card or the module is a computer system including a microprocessor, ROM, and RAM. The IC card or the module may include the above super multifunctional LSI. The functions of IC card or the module are achieved by the microprocessor operating in accordance with the computer program. The IC card or the module may be tamper-resistant.
(4) The present disclosure may be the methods described above. Moreover, the present disclosure may be a computer program to achieve the methods using a computer, and may be a digital signal representing the computer program.

Moreover, the present disclosure may be the computer program or the digital signal stored in a computer-readable recording medium, such as a flexible disk, a hard disk, a CD-ROM, an MO, a DVD, a DVD-ROM, a DVD-RAM, a Blu-ray (registered trademark) Disc (BD), or semiconductor memory. Moreover, the present disclosure may be the digital signal recorded on these recording media.

Moreover, the present disclosure may relate to transmission of the computer program or the digital signal via, for example, a network or data broadcasting typified by a telecommunication line, a wireless or wired communication line, or the Internet.

Moreover, the present disclosure may be a computer system including a microprocessor and memory. The computer program may be stored in the memory, and the microprocessor may operate in accordance with the computer program.

Moreover, another independent computer system may be caused to perform the method by transferring the program or the digital signal stored in the recording medium to the independent computer system or transferring the program or the digital signal to the independent computer system via, for example, the network.
(5) The above embodiment and another embodiment may be combined.

### (Supplementary Notes)

The following techniques are disclosed by the statements in the above embodiment and so forth.

### (Technique 1)

A display control device including:
a first-operation detector that detects a first operation to output and display a target image on a second display device different from a first display device, the target image being an image displayed on the first display device among a plurality of display devices each of which is configured to display an image;
a first-selection acceptor that, when the first operation is detected, accepts, via the second display device, a first selection as to whether to approve or disapprove outputting and displaying the target image on the second display device; and
a controller that outputs the target image to the second display device to cause the second display device to display the target image when approval for outputting and displaying the target image on the second display device is selected.

### (Technique 2)

The display control device according to technique 1, in which
when disapproval for outputting and displaying the target image on the second display device is selected, the controller prevents the second display device from displaying the target image.

### (Technique 3)

The display control device according to technique 1 or 2, including:
a first-setting acceptor that accepts a first setting to prevent the second display device from displaying the target image, in a situation where neither the approval nor disapproval for outputting and displaying the target image on the second display device is selected within a predetermined period from start of acceptance of the first selection, in which
the controller prevents the second display device from displaying the target image when the first setting is set in the situation where neither the approval nor the disapproval for outputting and displaying the target image on the second display device is selected within the predetermined period.

### (Technique 4)

The display control device according to any one of techniques 1 to 3, including:
a second-selection acceptor that, when the first operation is detected, accepts, via the first display device, a second selection as to whether to stop outputting and displaying the target image on the second display device, in which
if to stop outputting and displaying the target image on the second display device is selected, the controller stops the target image from being output to and displayed on the second display device.

### (Technique 5)

The display control device according to any one of techniques 1 to 4, in which
the first-selection acceptor accepts the first selection as a result of causing the second display device to display (i) options as to whether to approve or disapprove outputting and displaying the target image on the second display device or (ii) a thumbnail of the target image, and
when an approval option for outputting and displaying the target image on the second display device is selected from the options, or when the thumbnail is tapped, the controller outputs the target image to the second display device to cause the second display device to display the target image.

### (Technique 6)

The display control device according to technique 5, in which
the first-selection acceptor determines a position at which to display the options or the thumbnail on the second display device, according to a position of the first display device relative to the second display device, and causes the options or the thumbnail to be displayed at the position determined.

### (Technique 7)

The display control device according to any one of techniques 1 to 6, in which
the plurality of display devices include display devices that have a one-to-one correspondence with a plurality of seats in a vehicle including the plurality of seats, and are each configured to display the image viewable by a person seated in a corresponding one of the plurality of seats,
the display control device includes:
an occupancy information obtainer that obtains occupancy information indicating whether the person is seated in each of the plurality of seats, from an occupancy information detector that detects the occupancy information; and
an occupancy determiner that determines whether the person is seated in each of the plurality of seats according to the occupancy information,
when the first operation is detected, if the person is not seated in the seat corresponding to the second display device, the first-selection acceptor does not accept the first selection, and
when the person is not seated in the seat corresponding to the second display device, the controller outputs the target image to the second display device to cause the second display device to display the target image.

### (Technique 8)

The display control device according to any one of techniques 1 to 6, in which
the plurality of display devices include display devices that have a one-to-one correspondence with a plurality of seats in a vehicle that includes the plurality of seats including a driver's seat, and are each configured to display the image viewable by a person seated in a corresponding one of the plurality of seats,
the display control device includes:
   a driving information obtainer that obtains driving information indicating a driving status of the vehicle based on driving of the person in the driver's seat, from a driving information detector that detects the driving information; and
a decision maker that, when a display device corresponding to the driver's seat is the second display device, determines whether to accept the first selection according to the driving information,
   when the first operation is detected, if the first selection is determined not to be accepted, the first-selection acceptor does not accept the first selection, and
when the first selection is determined not to be accepted, the controller prevents the second display device from displaying the target image.

### (Technique 9)

The display control device according to any one of techniques 1 to 8, including:
a second-setting acceptor that accepts a second setting to not accept the first selection when each of the plurality of display devices is the second display device, in which
when the first operation is detected, if the second setting is set for a display device that is the second display device among the plurality of display devices, the first-selection acceptor does not accept the first selection, and
when the second setting is set for the display device that is the second display device among the plurality of display devices, the controller outputs the target image to the second display device to cause the second display device to display the target image.

### (Technique 10)

The display control device according to any one of techniques 1 to 9, including:
a second-operation acceptor that, when the first operation is detected, accepts, via the second display device, a second operation to output and display the target image on a third display device different from the first display device and the second display device among the plurality of display devices, in which
when the second operation is performed, the controller outputs the target image to the third display device to cause the third display device to display the target image.

### (Technique 11)

A display control method including:
detecting a first operation to output and display a target image on a second display device different from a first display device, the target image being an image displayed on the first display device among a plurality of display devices each of which is configured to display an image;
when the first operation is detected, accepting, via the second display device, a first selection as to whether to approve or disapprove outputting and displaying the target image on the second display device; and
when approval for outputting and displaying the target image on the second display device is selected, outputting and displaying the target image on the second display device.

### (Technique 12)

A program for causing a computer to execute the display control method according to technique 11.

### Further Information about Technical Background to this Application

The disclosures of the following patent applications including specification, drawings, and claims are incorporated herein by reference in their entirety: Japanese Patent Application No. 2023-169320 filed on Sep. 29, 2023 and PCT International Application No. PCT/JP2024/028519 filed on Aug. 8, 2024.

### INDUSTRIAL APPLICABILITY

The present disclosure is applicable to, for example, a device that controls displaying of an image on a display device.

1. A display control device comprising:
a processor; and
memory connected to the processor, wherein
using the memory, the processor:
detects a first operation to output and display a target image on a second display device different from a first display device, the target image being an image displayed on the first display device among a plurality of display devices each of which is configured to display an image;
accepts, via the second display device, a first selection as to whether to approve or disapprove outputting and displaying the target image on the second display device, when the first operation is detected; and
outputs the target image to the second display device to cause the second display device to display the target image when approval for outputting and displaying the target image on the second display device is selected.

2. The display control device according to claim 1, wherein
when disapproval for outputting and displaying the target image on the second display device is selected, the processor prevents the second display device from displaying the target image.

3. The display control device according to claim 1, wherein
the processor accepts a first setting to prevent the second display device from displaying the target image, in a situation where neither the approval nor disapproval for outputting and displaying the target image on the second display device is selected within a predetermined period from start of acceptance of the first selection, and
the processor prevents the second display device from displaying the target image when the first setting is set in the situation where neither the approval nor the disapproval for outputting and displaying the target image on the second display device is selected within the predetermined period.

4. The display control device according to claim 1, wherein
when the first operation is detected, the processor accepts, via the first display device, a second selection as to whether to stop outputting and displaying the target image on the second display device, and
if to stop outputting and displaying the target image on the second display device is selected, the processor stops the target image from being output to and displayed on the second display device.

5. The display control device according to claim 1, wherein
in accepting the first selection, the processor accepts the first selection as a result of causing the second display device to display (i) options as to whether to approve or disapprove outputting and displaying the target image on the second display device or (ii) a thumbnail of the target image, and
in outputting the target image to the second display device to cause the second display to display the target image, when an approval option for outputting and displaying the target image on the second display device is selected from the options, or when the thumbnail is tapped, the processor outputs the target image to the second display device to cause the second display device to display the target image.

6. The display control device according to claim 5, wherein
in accepting the first selection, the processor determines a position at which to display the options or the thumbnail on the second display device, according to a position of the first display device relative to the second display device, and causes the options or the thumbnail to be displayed at the position determined.

7. The display control device according to claim 1, wherein
the plurality of display devices include display devices that have a one-to-one correspondence with a plurality of seats in a vehicle including the plurality of seats, and are each configured to display the image viewable by a person seated in a corresponding one of the plurality of seats,
the processor:
obtains occupancy information indicating whether the person is seated in each of the plurality of seats; and
determines whether the person is seated in each of the plurality of seats according to the occupancy information, and
when the first operation is detected, if the person is not seated in the seat corresponding to the second display device, the processor does not accept the first selection, and outputs the target image to the second display device to cause the second display device to display the target image.

8. The display control device according to claim 1, wherein
the plurality of display devices include display devices that have a one-to-one correspondence with a plurality of seats in a vehicle that includes the plurality of seats including a driver's seat, and are each configured to display the image viewable by a person seated in a corresponding one of the plurality of seats,
the processor:
obtains driving information indicating a driving status of the vehicle based on driving of the person in the driver's seat; and
determines whether to accept the first selection according to the driving information, when a display device corresponding to the driver's seat is the second display device, and
when the first operation is detected, if the first selection is determined not to be accepted, the processor does not accept the first selection, and prevents the second display device from displaying the target image.

9. The display control device according to claim 1, wherein
the processor accepts a second setting to not accept the first selection when each of the plurality of display devices is the second display device, and
when the first operation is detected, if the second setting is set for a display device that is the second display device among the plurality of display devices, the processor does not accept the first selection, and outputs the target image to the second display device to cause the second display device to display the target image.

10. The display control device according to claim 1, wherein
when the first operation is detected, the processor accepts, via the second display device, a second operation to output and display the target image on a third display device different from the first display device and the second display device among the plurality of display devices, and
when the second operation is performed, the processor outputs the target image to the third display device to cause the third display device to display the target image.

11. A display control method performed by a computer, the display control method comprising:
detecting a first operation to output and display a target image on a second display device different from a first display device, the target image being an image displayed on the first display device among a plurality of display devices each of which is configured to display an image;
when the first operation is detected, accepting, via the second display device, a first selection as to whether to approve or disapprove outputting and displaying the target image on the second display device; and
when approval for outputting and displaying the target image on the second display device is selected, outputting and displaying the target image on the second display device.
